(19) United States
(12) Patent Application Publication
(10) Pub. No.: US 2014/0028592 A1
(43) Pub. Date: Jan. 30, 2014

(54) Haptic Input Stylus

(71) Applicants: Hong Xing Wang, Shenzhen (CN); Rong Guan Zhou, Shenzhen (CN)

(72) Inventors: Hong Xing Wang, Shenzhen (CN); Rong Guan Zhou, Shenzhen (CN)

(73) Assignees: AAC TECHNOLOGIES (NANJING) CO., LTD., Nanjing (CN); AAC ACOUSTIC TECHNOLOGIES (SHENZHEN) CO., LTD., Shenzhen (CN)

(21) Appl. No.: 13/945,047

(22) Filed: Jul. 18, 2013

(30) Foreign Application Priority Data
Jul. 24, 2012 (CN) 201210257899.6

(51) Int. Cl. G06F 3/0354

(52) U.S. Cl. CPC G06F 3/03545
USPC 345/173; 345/179

(57) ABSTRACT

Disclosed is a haptic input system. The system includes a user interface device and a stylus cooperating with the user interface device. The stylus includes a vibrator driven by vibrating signals provided by the user interface device to vibrate to generate haptic feedback and to drive the user interface device to generate audible sounds.

### FIELD OF THE INVENTION

The disclosure described herein relates generally to input devices, and more particularly, to an input stylus capable of providing haptic and audible feedback to a user.

### DESCRIPTION OF RELATED ART

As disclosed in U.S. Patent Publication No. 20120127088, existing touch-based user interface devices typically have a touch panel and a visual display component. The touch panel may include a touch sensitive surface that, in response to detecting a touch event, generates a signal that can be processed and utilized by other components of an electronic device. The touch sensitive surface may be separate from the display component, such as in the case of a trackpad, or may be integrated into or positioned in front a display screen, such as in the case of a display touch screen.

Display touch screens may show textual and/or graphical display elements representing selectable virtual buttons or icons, and the touch sensitive surface may allow a user to navigate the content displayed on the display screen. Typically, a user may move one or more objects, such as a finger, a stylus, across the touch sensitive surface in a pattern that the device translates into an input command. As an example, some electronic devices allow the user to select a virtual button by tapping a portion of the touch sensitive surface corresponding to the virtual button. Some electronic devices may even detect more than one simultaneous touch events in different locations on the touch screen.

Generally, input devices do not provide haptic feedback to a user in response to interactions with the input device. The user can typically only feel the rigid surface of the touch screen, making it difficult to find icons, hyperlinks, text boxes, or other user-selectable input elements on the display. An input device capable of generating haptic feedback may help a user navigate content displayed on the display screen, and may further serve to enhance the content of various applications by creating a more appealing and realistic user interface. “Haptic feedback” may be any tactile feedback. Examples include forces, vibrations, and/or motions that may be sensed by the user.

For achieving a device having haptic feedback function, U.S. Patent Publication No. 20120127088 provides a solution. This solution discloses that a haptic input device may be configured to interface with a touch-based user interface device, such as a touch screen. The touch-based user interface device may further include one or more input sensors, such as force sensors or position sensors that are configured to sense one or more characteristics of a haptic input device as it engages the touch screen. For example, the one or more characteristics may include a position of the device relative to the touch screen, a pressure being applied on the touch screen surface by the haptic input device, an angle of the input device relative to the touch screen, and the like. The touch-based user interface device may determine a haptic response based on the one or more characteristics and transmit the haptic response to the haptic input device. The haptic input device may include a haptic actuator that generates haptic feedback based on the received haptic response. The haptic response may take the form of a control signal that drives a haptic actuator or a look-up value that corresponds to a control signal stored in a look-up table. In some embodiments, the haptic input device may also include additional sensors configured to sense one or more characteristics of the haptic input device, such as the orientation of the haptic input device, the acceleration of the device relative to the touch screen surface, and so on.

However, this solution provides haptic feedback only based on the touch screen. Another word, to achieve the haptic feedback function, the touch-based user interface device must provide actuators to driving the screen to vibrating for providing haptic feedback. From another aspect, if a user wants to use the haptic input device, the user shall prepare a touch-based user interface device having haptic feedback components to cooperate with the haptic input device. If the user does not have a touch-based user interface device with haptic feedback function, the haptic input device cannot work as desired.

Therefore, an improved haptic input stylus is provided in the present disclosure to solve the problem mentioned above.

### BRIEF DESCRIPTION OF THE DRAWINGS

FIG. 1 illustrates an embodiment of a system incorporating a haptic input stylus.

FIG. 2 illustrates a block diagram of a haptic input stylus which can be used in conjunction with the system illustrated in FIG. 1.

FIG. 3 is a block diagram illustrating the cooperation between a driving unit and a decoder incorporated in the haptic input stylus as shown in FIG. 2.

FIG. 4 is a block diagram illustrating the operation principle of the system illustrated in FIG. 1.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENT

Reference will now be made to describe the exemplary embodiment of the present invention in detail.

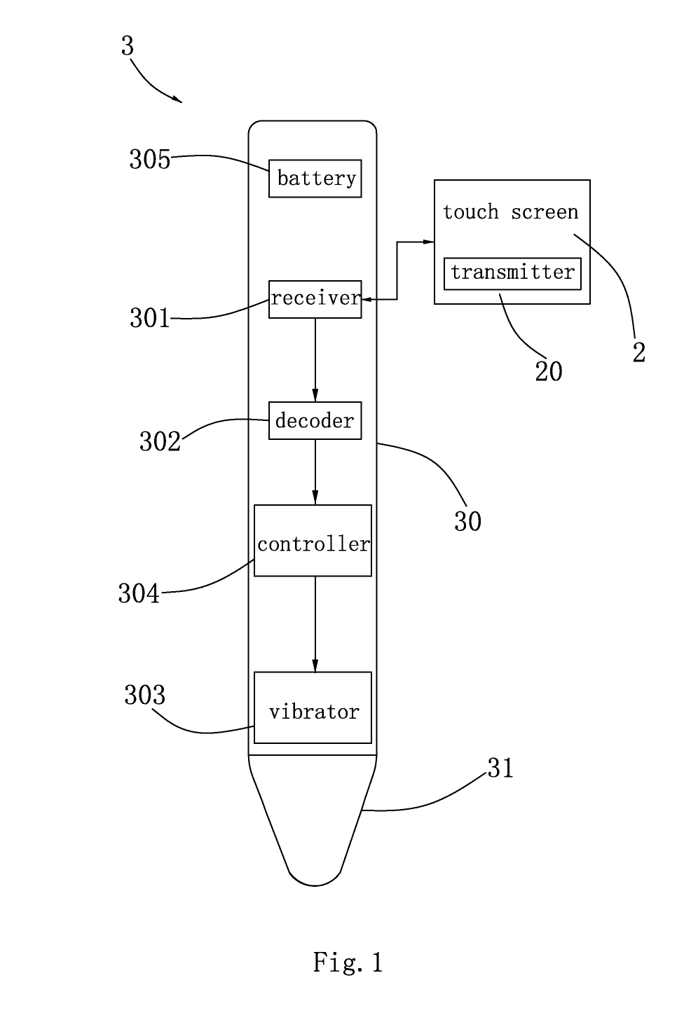

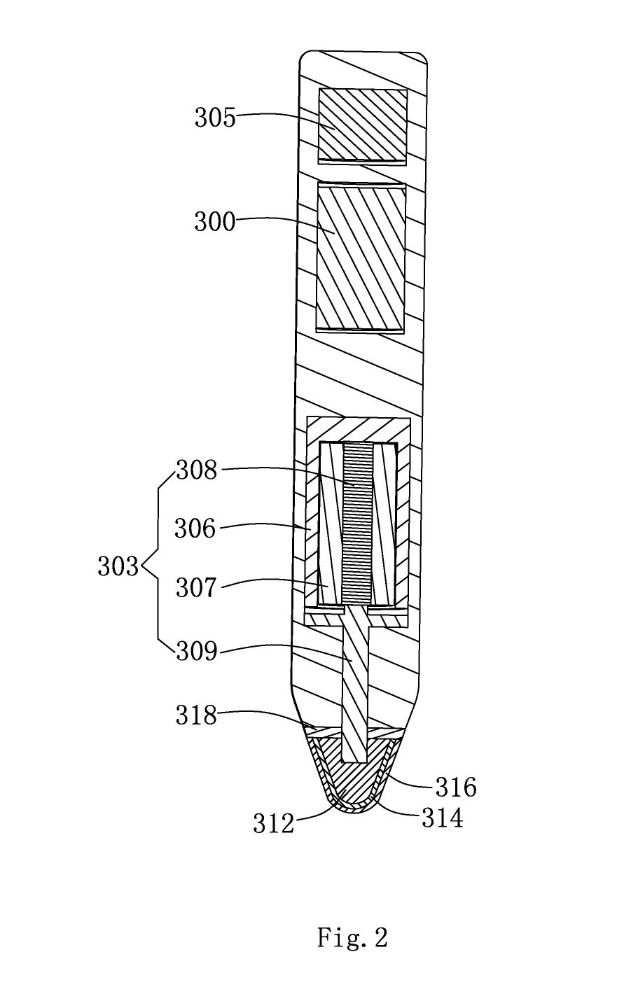

Referring to FIGS. 1-2, the present disclosure provides a haptic system comprising a user interface device and a haptic input stylus 3. The user interface device including a touch screen 2 and a transmitter 20. The transmitter 20 is capable of sending signals to the haptic input stylus 3 via a wireless network or a cable. The haptic input stylus 3 includes a pen body 30 and a pen tip 31, and the pen tip 31 is arranged at an end of the pen body 30.

The pen tip 31 of the stylus 3 includes a rigid layer 312, a first soft layer 314, and a smooth layer 316. The first soft layer 314 is located between the rigid layer 312 and the smooth layer 316, and the smooth layer 316 is the outermost layer of the pen tip 31. The rigid layer 312 is surrounded by the first soft layer 314, which can avoid noise produced by the contact between the pen tip 31 and the touch screen 2, and can prevent the touch screen from damage by the direct contact between the rigid layer 312 and the touch screen 2. The smooth layer 316 is used to directly contact with the touch screen 2. The haptic input stylus 3 further includes a second soft layer 318 located between the rigid layer 312 and the pen body 30 for reducing the vibration of the pen body 30 and reducing the suppression of the pen tip 31.

It is optional that the first and second soft layers may be made from rubber, and the smooth layer 316 may be made from plastic.

The pen body 30 comprises a receiver 301, a decoder 302, a vibrator 303, a controller 304, and a battery 305. The vibrator 303 is located in the front of the pen body 30 and is arranged to contact with the pen tip 31. The receiver 301 is used to receive contacting signals from external component. In the embodiment, the external component is the user interface device. When the pen tip 31 of the haptic input stylus 3 contacts with the touch screen 2 of the user interface device, the user interface device produces contacting signals and then transmits the contacting signals to the receiver 301 of the haptic input stylus 3 via the transmitter 20. After receiving the contacting signals from the transmitter 20, the receiver 301 sends the contacting signals to the decoder 302 of the haptic input stylus 3. The decoder 302 decodes the contacting signals and transmits the decoded contacting signals to the controller 304. In the embodiment, the receiver 301, the decoder 302 and the controller 304 are integrated on one printed circuit board 300. In fact, all the elements could be separated arranged in the stylus.

The vibrator 303 is electrically connected to the controller 304.

The decoder 302 is also electrically connected to the controller 304 for transmitting the decoded contacting signals to the controller 304. The controller 304 will produce vibrating signals according the decoded contacting signals for transmitting to the vibrator 303. The vibrator 303 vibrates corresponding to the vibrating signals provided by the controller 304.

In the embodiment, the vibrator 303 includes a magnet 306, a coil 307, a vibrating unit 308, and a contacting member 309 coupled to the vibrating unit 308. The coil 307 is received in the magnet 306 and is used to receive the vibrating signals from the controller 304, and the vibrating unit 308 is surrounded by the coil 307. The contacting member 309 is located between the vibrating unit 308 and the pen tip 31, with two ends thereof connecting with the vibrating unit and the pen tip, respectively. In the embodiment, the contacting member 309 connects with the rigid layer 312 of the pen tip 31. By virtue of the cooperation between the coil 307 and the magnet 306, the vibrating unit 308 vibrates corresponding to the vibrating signals from the controller 304.

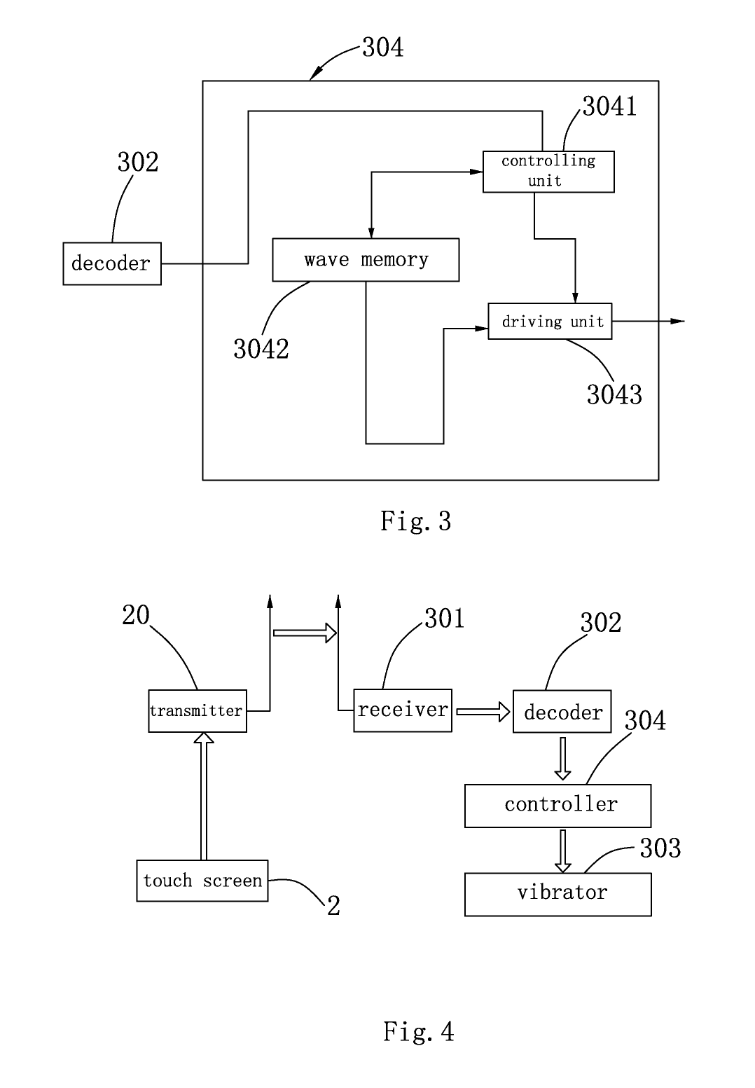

Referring to FIGS. 3-4, the controller 304 includes a controlling unit 3041, a wave memory 3042, and a driving unit 3043. The controlling unit 3041 would select appropriate vibrating signals which are pre-stored in the wave memory 3042 according to the decoded contacting signals and then transmit the appropriate vibrating signals to the driving unit 3043. The driving unit 3043 drives the vibrator 303 to vibrate. Different vibrating signals are pre-stored in the wave memory 3042 for meeting different haptic requirements.

In this embodiment, the battery 305 is located at the rare end of the haptic input stylus 3 for providing power to the haptic input stylus 3.

In this embodiment, when contacting the touch screen 2, the haptic input stylus 3 provides haptic feedback to the user by virtue of the vibration of the vibrator 303 thereof, and the vibration of the vibrator 303 will cause the movement of the contacting member 309. By the movement of the contacting member 309, the pen tip 31 is actuated to vibrate via the rigid layer 312. Further, the touch screen 2 is forced to vibrate by the pen tip 31 for generating sound. By virtue of the vibrator 303, the controller 304, and the receiver 301, the haptic input stylus 3 could provide haptic and audible feedback to the user, whether the user interface device provides a haptic component or not.

While the present disclosure has been described with reference to the specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. A haptic input stylus, comprising:
a pen body;
a pen tip connecting to an end of the pen body;
a battery accommodated in the pen body;
a receiver accommodated in the pen body for receiving contacting signals from external component;
a decoder accommodated in the pen body and electrically connected to the receiver for decoding the contacting signals from the receiver;
a controller accommodated in the pen body and electrically connected to the decoder for producing vibrating signals;
a vibrator accommodated in the pen body and electrically connected to the controller for generating haptic vibration corresponding to the vibrating signals from the controller.

2. The haptic input stylus as described in claim 1, wherein, the pen tip comprises a rigid layer, a first soft layer, and a smooth layer, the first soft layer being located between the rigid layer and the smooth layer.

3. The haptic input stylus as described in claim 2, wherein, the rigid layer is surrounded by the first soft layer.

4. The haptic input stylus as described in claim 2, wherein, the pen tip further comprises a second soft layer located between the rigid layer and the pen body.

5. The haptic input stylus as described in claim 1, wherein, the vibrator comprises a magnet, a coil, a vibrating unit, and a contacting member coupled to the vibrating unit.

6. The haptic input stylus as described in claim 5, wherein, the coil is located in the magnet, and the vibrating unit is surrounded by the coil.

7. The haptic input stylus as described in claim 5, wherein, the contacting member is located between the vibrating unit and the pen tip, with two ends thereof connecting with the vibrating unit and the pen tip, respectively.

8. The haptic input stylus as described in claim 1, wherein, the controller includes a controlling unit, a wave memory for pre-storing different vibrating signals therein, and a driving unit for driving the vibrator.

9. A haptic feedback system, comprising:
a haptic input stylus including a receiver and a vibrator;
a user interface device including a touch screen and a transmitter for transmitting contacting signals produced by the contact between the haptic input stylus and the touch screen to the receiver of the stylus for driving the vibrator and the touch screen to vibrate for generating haptic and audible feedbacks.

10. The haptic feedback system as described in claim 9, wherein, the haptic input stylus further comprises a decoder electrically connected to the receiver for decoding the contacting signals from the transmitter.

11. A haptic input system, comprising:
a user interface device including a touch screen and a transmitter;
a pen body;
a pen tip connecting to an end of the pen body;
a battery accommodated in the pen body;
a receiver accommodated in the pen body for receiving contacting signals from the transmitter of the user interface device;
a decoder accommodated in the pen body and electrically connected to the receiver for decoding the contacting signals from the receiver;
a controller accommodated in the pen body and electrically connected to the decoder for producing vibrating signals;
a vibrator accommodated in the pen body and electrically connected to the controller for generating haptic vibration corresponding to the vibrating signals from the controller;
the touch screen driven by the vibrator foe generating audible sounds.
